(19) United States
(12) Patent Application Publication
(10) Pub. No.: US 2008/0318063 A1
(43) Pub. Date: Dec. 25, 2008

(54) Glass laminates with improved weatherability

(76) Inventor: Jerrel C. Anderson, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/821,266

(22) Filed: Jun. 22, 2007

(51) Int. Cl. B32B 17/10

(52) U.S. Cl. 428/430

(57) ABSTRACT

A glass laminate comprising: (i) a first glass outer layer having its inner surface primed with an adhesive material and being positioned next to and adhered to, (ii) a first polymeric interlayer comprising a first polymer selected from partially or fully neutralized ionomeric copolymers of alpha olefins and alpha,beta-unsaturated carboxylic acids having from 3 to 8 carbons, which is adjacent to and adhered to, (iii) a first surface-treated polyester film.

### FIELD OF THE INVENTION

The present invention relates to laminated glass with improved weatherability.

### BACKGROUND OF THE INVENTION

Laminated safety glass has been used in the windshields of automobiles and the windows of buildings since the late 1930's. Safety glass typically consists of a sandwich of two glass sheets or panels bonded together by means of an interlayer formed of polymeric film(s) or sheet(s) and placed between the two glass sheets. One or both of the glass sheets may be replaced by optically clear rigid polymer sheets or hardcoats. When the laminated structure or sandwich is impacted by a rock or other object, the interlayer acts to absorb some of the impact energy. If the energy is sufficient to break the first sheet of glass, the interlayer reduces the total energy transmitted to the second sheet and spreads the energy from the crack across a wider area. If the energy is sufficient to also crack the second sheet of glass, the interlayer becomes the only structural element left to resist penetration of the rock. Accordingly, the tear resistance of the polymer sheet from which the interlayer is made is a critical performance parameter.

U.S. Pat. No. 7,189,457 describes glass/plastic laminates (that is, laminates having a glass plate as one outer layer and a hard plastic or hardcoated plastic as the other outer layer) comprising a poly(vinyl butyral) (PVB) or ionomer interlayer and a hardcoated polyester film outer layer.

U.S. Pat. No. 7,189,457 describes that adhesion between the interlayer and hardcoated polyester films is improved by priming the film with a poly(allyl amine) coating. Polyester films treated with such a poly(allyl amine) coating perform better than polyester films treated by electrical discharge, plasma treatments, or flame treatment.

### SUMMARY OF THE INVENTION

The invention is directed to a glass laminate comprising:

(i) a first glass outer layer having its inner surface primed with an adhesive material and being positioned next to and adhered to,

(ii) a first polymeric interlayer comprising a first polymer selected from partially or fully neutralized ionomeric copolymers of alpha olefins and alpha,beta-unsaturated carboxylic acids having from 3 to 8 carbons (“ionomer”), which is adjacent to and adhered to,

(iii) a first surface-treated polyester film.

Preferably the polyester film is surface-treated or primed with a poly(alkyl amine), preferably poly(allyl amine).

In a preferred embodiment, the first polyester film has its second surface that is farther away from the first polymeric interlayer coated with an abrasion resistant hardcoat. Preferably the abrasion resistant hardcoat is formed of a material selected from the group consisting of polysiloxanes, cross-linked polyurethanes, and oligomeric composition prepared by the reaction of (A) hydroxyl-containing oligomer with isocyanate-containing oligomer or (B) anhydride-containing oligomer with epoxide-containing compound.

In one preferred embodiment, the glass laminate further comprises: (iv) a second polymeric interlayer comprising a second polymer selected from the group consisting of poly(vinyl acetals), acid copolymers of alpha olefins and alpha,beta-unsaturated carboxylic acid having from 3 to 8 carbons (“acid copolymer”), ionomer, polyurethanes, polyvinyl chlorides, and ethylene vinyl acetates (preferably, the ionomer or a poly(vinyl acetal), such as poly(vinyl butyral) which has its first surface adjacent to and adhered to the first polyester film and its second surface adjacent to and adhered to, (v) a second polyester film. The second polyester film can be surface-treated. In a preferred embodiment, (a) the second polymer of the second polymeric interlayer is selected from the ionomer (preferably the same or similar ionomer as the first layer); (b) the first polyester film has both of its surfaces primed with the poly(alkyl amine), preferably poly(allyl amine); and (c) the second polyester film has its first surface that is adjacent to the second polymeric interlayer primed with poly(alkyl amine), preferably poly(allyl amine) and its second surface coated with an abrasion resistant hardcoat. In another preferred embodiment, (a) the second polymer of the second polymeric interlayer is selected from the poly(vinyl acetals), wherein the poly(vinyl acetal) is preferably poly(vinyl butyrals); and (b) the second polyester film has its first surface in contact with the second polymeric layer and its second surface coated with an abrasion resistant hardcoat.

In yet another preferred embodiment, the glass laminate additionally comprises:

(vi) a third polymeric interlayer comprising a third polymer selected from the group consisting of poly(vinyl butyrals), acid copolymers, ionomer, polyurethanes, poly(vinyl acetals), polyvinyl chlorides, and ethylene vinyl acetates (preferably, the ionomer or a poly(vinyl acetal), such as poly(vinyl butyral), which has its first surface adjacent to and adhered to the second polyester film and its second surface adjacent to and adhered to, (vii) a third polyester film. The third polyester film can be surface-treated. In one preferred form of this embodiment, (a) the second and third polymers of the second and third polymeric interlayers are ionomers (preferably the same or similar ionomer as the first layer); (b) the first and second polyester films are primed with the poly(alkyl amine), preferably poly(allyl amine) on both surfaces; and (c) the third polyester film has its first surface that is adjacent to the third polymeric layer primed with the poly(alkyl amine), preferably poly(allyl amine) and its second surface coated with an abrasion resistant hardcoat. In another preferred form of this embodiment, (a) the second polymer of the second polymeric interlayer is poly(vinyl butyral); (b) the third polymer of the third polymeric interlayer is ionomer; and (c) the third polyester film has its first surface that is adjacent to the third polymeric layer primed with poly(alkyl amine), preferably poly(allyl amine) and its second surface coated with an abrasion resistant hardcoat.

In an addition preferred embodiment, the glass laminate further comprises: (iv) a second polymeric interlayer comprising a second polymer selected from the group consisting of poly(vinyl acetals), acid copolymers, ionomer, polyurethanes, polyvinyl chlorides, and ethylene vinyl acetates (preferably, the ionomer or a poly(vinyl acetal), such as poly(vinyl butyral), which has its first surface adjacent to and adhered to the first polyester film and its second surface adjacent to, (v) a second glass outer layer.

In yet a further embodiment, (a) the second polymer of the second polymeric interlayer is ionomer; (b) the first polyester film has both of its surfaces primed with the poly(alkyl amine), preferably poly(allyl amine); and (c) the second glass outer layer has its inner surface, which is adjacent to the second polymeric layer, primed with a second adhesive material, preferably selected from the group consisting of silanes and poly(alkyl amines).

Some preferred embodiments consist essentially of:
(i) the first glass outer layer having its inner surface primed with the adhesive material, (ii) the first polymeric interlayer, and (iii) the first polyester film having its first surface primed with the poly(alkyl amine) and its second surface coated with the abrasion resistant hardcoat.
(i) the first glass outer layer having its inner surface primed with the adhesive material, (ii) the first polymeric interlayer, (iii) the first polyester film having both surfaces primed with the poly(alkyl amine), preferably poly(allyl amine), (iv) the second polymeric interlayer, and (v) the second polyester film having its first surface primed with the poly(alkyl amine), preferably poly(allyl amine) and its second surface coated with the abrasion resistant hardcoat.
(i) the first glass outer layer having its inner surface primed with the adhesive material, (ii) the first polymeric interlayer, (iii) the first polyester film having at least the surface that is adjacent to the first polymeric interlayer primed with the poly(alkyl amine), preferably poly(allyl amine), (iv) the second polymeric interlayer, and (v) the second polyester film having one surface that is farther away from the second polymeric layer coated with the abrasion resistant hardcoat.
(i) the first glass outer layer having its inner surface primed with the adhesive material, (ii) the first polymeric interlayer, (iii) the first polyester film having both surfaces primed with the poly(alkyl amine), preferably poly(allyl amine), (iv) the second polymeric interlayer, (v) the second polyester film having both surfaces primed with the poly(alkyl amine), preferably poly(allyl amine), (vi) the third polymeric interlayer, and (vii) the third polyester film having its first surface primed with the poly(alkyl amine), preferably poly(allyl amine), and its second surface coated with the abrasion resistant hardcoat.
(i) the first glass outer layer having its inner surface primed with the adhesive material, (ii) the first polymeric interlayer, (iii) the first polyester film having at least the surface that is adjacent to the first polymeric interlayer primed with the poly(alkyl amine), preferably poly(allyl amine), (iv) the second polymeric interlayer, (v) the second polyester film having at least the surface that is farther away from the second polymeric interlayer primed with the poly(alkyl amine), preferably poly(allyl amine), (vi) the third polymeric interlayer, and (vii) the third polyester film having its first surface that is adjacent to the third polymeric interlayer primed with the poly(alkyl amine), preferably poly(allyl amine), and its second surface coated with the abrasion resistant hardcoat.
(i) the first glass outer layer having its inner surface primed with the adhesive material, (ii) the first polymeric interlayer, (iii) the first polyester film having both surfaces primed with the poly(alkyl amine), preferably poly(allyl amine), which is adjacent to and adhered to, (iv) the second polymeric interlayer, and (v) the second glass outer layer having its inner surface that primed with the adhesive material.
(i) the first glass outer layer having its inner surface primed with the adhesive material, (ii) the first polymeric interlayer, (iii) the first polyester film having at least one surface that is adjacent to the first polymeric interlayer primed with the poly(alkyl amine), preferably poly(allyl amine), (iv) the second polymeric interlayer, (v) the second glass outer layer.

Preferably the adhesive material is selected from the group consisting of silanes and poly(alkyl amines). In one preferred embodiment, the adhesive material is the silane. Preferably the silane is an amino-silane, wherein the inner amino-silanes is selected from the group consisting of (3-aminopropyl)trimethoxysilanes, (3-aminopropyl)triethoxysilanes, N-beta-(aminoethyl)-gamma-aminopropyl-trimethoxysilanes, N-(beta-aminoethyl) gamma-aminopropylmethyldimethoxysilanes, aminoethylaminopropyl silane triol homopolymers, vinylbenzylaminoethylaminopropyltrimethoxysilanes, and bis(trimethoxysilylpropyl)amines. In another preferred embodiment, the adhesive material is the poly(alkyl amine). Preferably the poly(alkyl amine) is selected from the group consisting of poly(vinyl amines), poly(allyl amines), and mixtures thereof.

Preferably the polyester film(s) are poly(ethylene terephthalate) films.

Preferably the ionomers are prepared from (a) alpha olefin selected from the group consisting of ethylene, propylene, 1-butene, 1-pentene, 1-hexene, 1-heptene, 3-methyl-1-butene, 4-methyl-1-pentene and mixtures thereof, and (b) alpha, beta-ethylenically unsaturated carboxylic acid comonomer selected from the group consisting of acrylic acid, methacrylic acid, itaconic acid, maleic acid, maleic anhydride, fumaric acid, monomethyl maleic acid and mixtures thereof. More preferably, the ionomers are prepared from (a) ethylene and (b) acrylic acid, methacrylic acid or mixtures thereof.

Preferably the ionomers have about 5 to about 90 percent of the carboxylic acids neutralized with a metal ion. Preferably to produce the ionomer copolymers, the parent acid copolymers are neutralized from about 5 to about 90%, or more preferably, from about 10 to about 50%, or most preferably, from about 20 to about 40%, with metallic ions, based on the total carboxylic acid content.

### BRIEF DESCRIPTION OF THE DRAWINGS

FIG. 1 is a cross-sectional view (not in scale) of one particular embodiment of the glass laminates disclosed herein. Specifically, this glass laminate structure consists of the following six (6) layers: (i) glass layer 10, (ii) adhesive primer 12, preferably formed of an adhesive material selected from silanes and poly(alkyl amines), (iii) ionomer layer 14, (iv) poly(alkyl amine) primer layer 16, (v) polyester layer 18, and (vi) layer anti-abrasion hardcoat 36.

FIG. 2 is a cross-sectional view (not in scale) of another particular embodiment of the glass laminates disclosed herein. Specifically, this glass laminate structure consists of the following ten (10) layers: (i) glass layer 10, (ii) adhesive layer 12, (iii) ionomer layer 14, (iv) poly(alkyl amine) primer layer 16, (v) polyester layer 18, (vi) poly(alkyl amine) primer layer 20, (vii) ionomer layer 22, (viii) poly(alkyl amine) primer layer 24, (ix) polyester layer 26, and (x) anti-abrasion hardcoat layer 36.

FIG. 3 is a cross-sectional view (not in scale) of yet another particular embodiment of the glass laminates disclosed herein. Specifically, this glass laminate structure consists of the following nine (9) layers: (i) glass layer 10, (ii) adhesive layer 12, (iii) ionomer layer 14, (iv) poly(alkyl amine) primer layer 16, (v) polyester layer 18, (vi) poly(alkyl amine) primer layer 20, (vii) ionomer layer 22, (viii) adhesive layer 38, and (ix) glass layer 40.

FIG. 4 is a cross-sectional view (not in scale) of yet another particular embodiment of the glass laminates disclosed herein. Specifically, this glass laminate structure consists of the following fourteen (14) layers: (i) glass layer 10, (ii) adhesive layer 12, (iii) ionomer layer 14, (iv) poly(alkyl amine) primer layer 16, (v) polyester layer 18, (vi) poly(alkyl amine) primer layer 20, (vii) ionomer layer 22, (viii) poly(alkyl amine) primer layer 24, (ix) polyester layer 26, (x) poly(alkyl amine) primer layer 28, (xi) ionomer layer 30, (xii) poly(alkyl amine) primer layer 32, (xiii) polyester layer 34, and (xiv) anti-abrasion hardcoat layer 36.

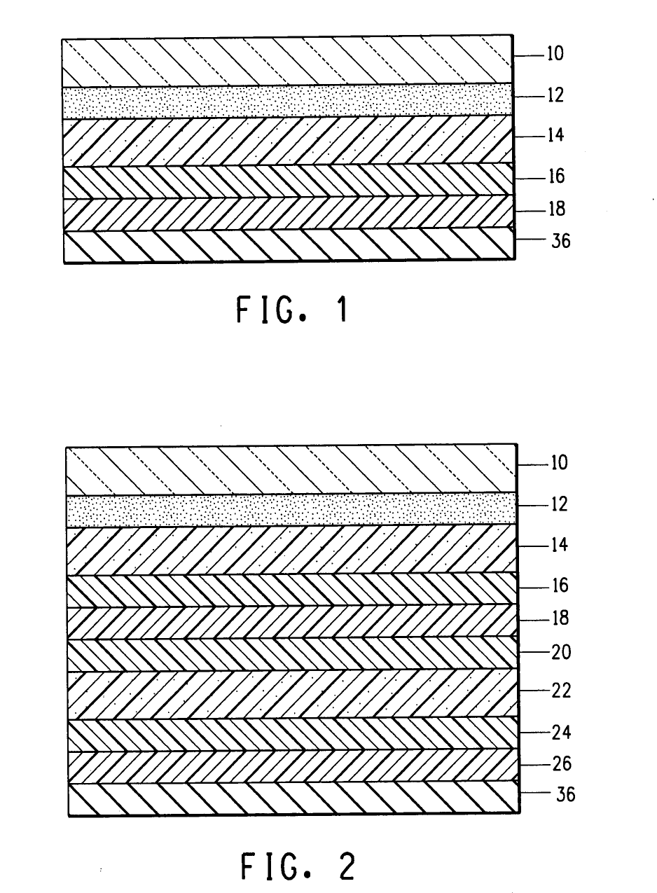

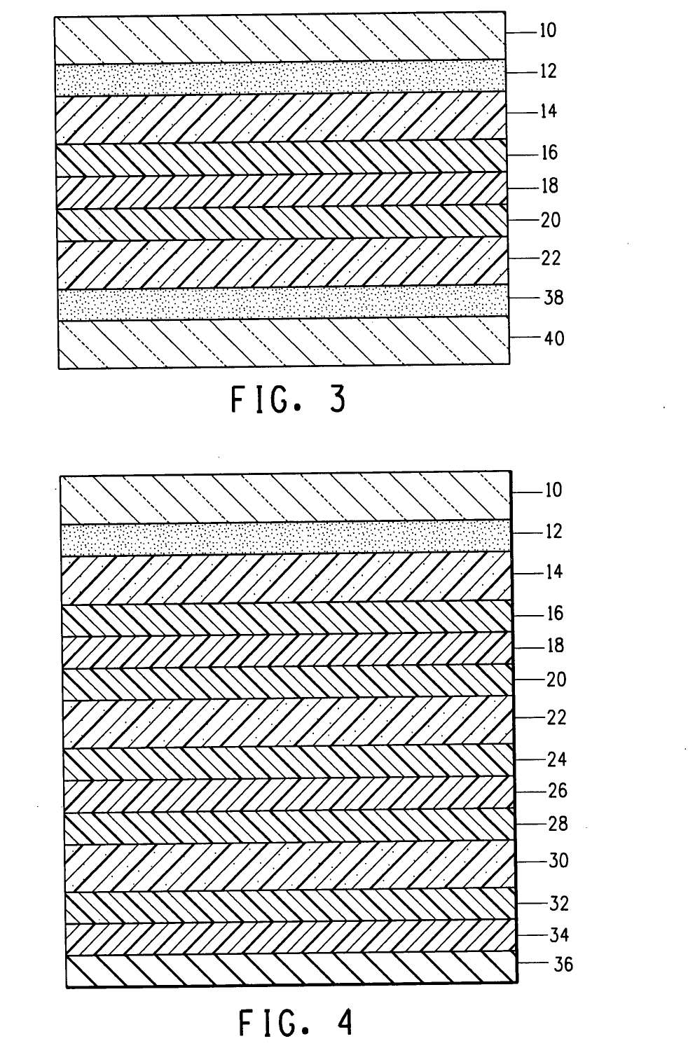

### DETAILED DESCRIPTION OF THE INVENTION

All publications, patent applications, patents, and other documents mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

In describing and/or claiming this invention, the term “copolymer” is used to refer to polymers containing two or more monomers.

The terms “finite amount” and “finite value” are used to refer to an amount that is greater than zero.

“Poly(vinyl butyral)” is used to refer to a vinyl resin resulting from the condensation of polyvinyl alcohol with butyraldehyde. The term “poly(vinyl butyral)” can also refer to a poly(vinyl butyral) composition further comprising plasticizer. Plasticizers are generally used in poly(vinyl butyral) interlayers.

The term “ionomer” is used to refer to a partially or fully neutralized thermoplastic copolymers of alpha-olefin and about 15 to about 30 wt % of α,β-ethylenically unsaturated carboxylic acid (based on the total weight of the ionomer copolymer). The preferred α,β-ethylenically unsaturated carboxylic acids have 3 to 8 carbons, and are preferably acrylic acid, methacrylic acid and mixtures thereof. The alpha olefin comonomers preferably contain from 2 to 10 carbon atoms and most preferred is ethylene. A preferred example of a thermoplastic ionomer polymer is a poly(ethylene-co-(meth)acrylic acid) fully or partially neutralized with a metal ion, such as are selected from the group consisting of sodium, lithium, magnesium, zinc, and mixtures thereof. Sometimes the ionomers are referred to as ionomers of the acid copolymers in order to describe the structure of the copolymers.

The alpha olefin comonomers preferably incorporate from 2 to 10 carbon atoms. Preferable alpha olefins include, but are not limited to, ethylene, propylene, 1-butene, 1-pentene, 1-hexene, 1-heptene, 3-methyl-1-butene, 4-methyl-1-pentene, and the like and mixtures thereof. More preferably, the alpha olefin is ethylene.

Preferably, the copolymer comprises about 18 to about 25 wt %, or more preferably, about 18 to about 23 wt %, of groups from the α,β-ethylenically unsaturated carboxylic acid, based on the total weight of the copolymer. The preferred alpha, beta-ethylenically unsaturated carboxylic acid comonomers include acrylic acid, methacrylic acid, itaconic acid, maleic acid, maleic anhydride, fumaric acid, monomethyl maleic acid, and mixtures thereof. Most preferred are acrylic acid, methacrylic acid and mixtures thereof.

Frequently the ionomer copolymers are described with respect to the melt index (MI) of the parent acid copolymers since this property is indicative of the molecular weight of the polymer, and since the melt index of the ionomer copolymers is impacted by the level and type of neutralization and thus is not always useful to compare the polymer molecular weight. The best way to determine the MI of the acid copolymer is to measure the value directly by analyzing the acid copolymer prior to neutralization. However, acid copolymer MI of an ionomer can also be estimated through correlation to other similar polymers or by reacidifying the ionomer to form the acid copolymer and testing the resulting acid copolymer. The parent acid copolymers preferably have a melt index (MI) of about 1 to about 60 grams/10 min as measured by ASTM D1238 at 190° C. using a 2160 g. (A similar ISO test is ISO 1133.) More preferably, the parent acid copolymer has a MI of less than about 50 grams/10 min, even more preferably has a MI of less than about 40 grams/10 min, and most preferably has a MI of about 30 grams/10 min or less. These ionomer copolymers are relatively tough, which is especially desirable since they are utilized in interlayers for safety laminates.

The ionomer copolymers are preferably neutralized from about 5 to about 90%, or more preferably, from about 10 to about 50%, or most preferably, from about 20 to about 40%, with metallic ions, based on the total carboxylic acid content of the copolymers as calculated for the non-neutralized copolymers.

The metallic ions may be monovalent, divalent, trivalent, multivalent, or mixtures therefrom. Useful monovalent metallic ions include, but are not limited to, sodium, potassium, lithium, silver, mercury, copper, and the like and mixtures thereof. Useful divalent metallic ions include, but are not limited to, beryllium, magnesium, calcium, strontium, barium, copper, cadmium, mercury, tin, lead, iron, cobalt, nickel, zinc, and the like and mixtures therefrom. Useful trivalent metallic ions include, but are not limited to, aluminum, scandium, iron, yttrium, and the like and mixtures therefrom. Useful multivalent metallic ions include, but are not limited to, titanium, zirconium, hafnium, vanadium, tantalum, tungsten, chromium, cerium, iron, and the like and mixtures therefrom. It is noted that when the metallic ion is multivalent, complexing agents, such as stearate, oleate, salicylate, and phenolate radicals are included, as disclosed within U.S. Pat. No. 3,404,134. The metallic ions are preferably monovalent or divalent metallic ions. More preferably, the metallic ions are selected from the group consisting of sodium, lithium, magnesium, zinc, and mixtures therefrom. Yet more preferably, the metallic ions are selected from the group consisting of sodium, zinc, and mixtures therefrom. The parent acid copolymers of the invention may be neutralized as disclosed in U.S. Pat. No. 3,404,134.

The ionomer copolymers may optionally contain other unsaturated comonomers. Specific examples of other unsaturated comonomers include, but are not limited to, methyl acrylate, methyl methacrylate, ethyl acrylate, ethyl methacrylate, isopropyl acrylate, isopropyl methacrylate, butyl acrylate, butyl methacrylate and mixtures thereof. In general, the ionomeric copolymers may incorporate 0 to about 50 wt %, or preferably, 0 to about 30 wt %, or more preferably, 0 to about 20 wt %, of the other unsaturated comonomer(s), based on the total weight of the copolymer.

Ionomer interlayers are available from E. I. du Pont de Nemours and Company (Wilmington, Del.) (DuPont) as DuPont™ SentryGlase Plus interlayer or SentryGlas® Plus SGP5000 interlayer.

The term “acid copolymer” is used to refer to a copolymer of an alpha olefin and an α,β-unsaturated carboxylic acid (preferably having from 3 to 8 carbons). The term “ethylene acid copolymer” is used to refer to certain acid copolymer where the alpha olefin is ethylene. In addition to referring to acid copolymers with respect to the description of the ionomer copolymers, below applicants refer to “acid copolymers” in describing certain interlayers. Such reference is to copolymers comprising an alpha-olefin and about 15 to about 30 wt % of an α,β-ethylenically unsaturated carboxylic acid based on the total weight of the acid copolymer that are not neutralized. (In the case of an ionomer copolymer at least about 5 percent of the carboxylic acids are neutralized with a metal ion, so by reference to there acid copolymers not being neutralized the presence of a very small or insignificant amount of a metal ion should not be considered to keep something from being considered an acid copolymer.) These copolymers can have all the same features as the ionomers as described herein, except that they are not neutralized. Thus, for instance, they can be made with the monomers described above and the preferred monomers, ratios, etc., are the same as those described above, and the preferred copolymers are made from an alpha olefin (or mixtures thereof) containing 2 to 10 carbon atoms, preferably ethylene, and about 15 to about 30 wt % (based on the total weight of the copolymer) of an alpha, beta-ethylenically unsaturated carboxylic acid having 3 to 8 carbons, preferably acrylic acid, methacrylic acid and mixtures thereof. Hence, poly(ethylene-co-(meth)acrylic acid) is an example of a preferred acid copolymer for making an interlayer.

The acid copolymers may be polymerized as disclosed in U.S. Pat. No. 3,404,134; U.S. Pat. No. 5,028,674; U.S. Pat. No. 6,500,888; and U.S. Pat. No. 6,518,365.

This invention resulted from the unexpected discovery that during weathering tests ionomer based glass/plastic laminates suffer unexpected major spontaneous de-lamination between the glass and the ionomeric interlayer, and that this problem can be overcome by priming the glass surface in contact with the ionomer interlayer with an adhesive material. That it is was unexpectedly discovered that over time, with further exposure to humidity, radiation, and heat, the ionomeric interlayer tends to peel away from the glass layer and become yellowish and even suffers “mud cracking” on its exposed surface. By contrast, the interface between the ionomeric interlayer sheet and the poly(ally amine) primed hardcoated polyester film does not suffer any de-lamination since the two more malleable (plastic) layers are adhered together so strongly by the poly(allyl amine) primer coating. The de-lamination between the glass and the ionomeric interlayer was particularly surprising because (a) glass/ionomer interlayer/glass laminates perform extremely well and have excellent glass/ionomer adhesion and (b) similar glass/poly(vinyl butyral) interlayer/PET/hardcoat laminates perform well in weathering tests.

In one embodiment, the invention is a glass/plastic laminate with improved weatherability. Specifically, the glass/plastic laminate comprises (i) a first outer layer formed of glass, in which the inner surface is primed with an adhesive material, preferably selected from the group consisting of silanes and poly(alkyl amines) and is adjacent to and adhered to (ii) a first interlayer sheet formed of a thermoplastic polymer selected from the group consisting of acid copolymers and ionomers thereof, polyurethanes, poly(vinyl acetals) (e.g., poly(vinyl butyral), such as Butacite® poly(vinyl butyral) interlayer), polyvinyl chloride, and ethylene vinyl acetates, which is in direct or indirect contact with, (iii) a second outer layer formed of a polyester film which has its outer surface hardcoated and preferably has its inner surface primed with a poly(alkyl amine) coating. Preferably, the polymer of the first interlayer is an ionomer. By “indirect”, it is meant that additional polymeric sheet(s) or film(s) are laminated in-between the first interlayer sheet and the hardcoated polyester film.

The term “glass” used herein is meant to include not only window glass, plate glass, silicate glass, “sheet glass”, low iron glass, tempered glass, tempered CeO-free glass, and float glass, but also includes colored glass, specialty glass (which are glasses including ingredients to control, e.g., solar heating), coated glass (which are glass coated with, e.g., sputtered metals, such as silver or indium tin oxide, for solar control purposes), E-glass, Toroglass, SOLEX® glass (Solutia, St. Louis, Mo.) and the like. Such specialty glasses are disclosed in, e.g., U.S. Pat. No. 4,615,989; U.S. Pat. No. 5,173,212; U.S. Pat. No. 5,264,286; U.S. Pat. No. 6,150,028; U.S. Pat. No. 6,340,646; U.S. Pat. No. 6,461,736; and U.S. Pat. No. 6,468,934. The type of glass to be selected for a particular laminate depends on the intended use. Of course, it should be readily recognized that glass is referring to sheets of glass.

The adhesive or adhesive material can be any adhesive (or primer) that is useful for adhering glass sheets to the described interlayers in laminates of the type described herein. Preferred adhesive materials are selected from the group consisting of silanes, particularly amino silanes, and poly(alkyl amines).

Exemplary silanes useful in the invention include, but are not limited to, vinyltriethoxysilane, vinyltrimethoxysilane, vinyltris(beta-methoxyethoxy)silane, gamma-methacryloxypropyltrimethoxysilane, beta-(3,4-epoxycyclohexyl)ethyltrimethoxysilane, gamma-glycidoxypropyltrimethoxysilane, gamma-glycidoxypropylmethyldiethoxysilane, vinyl-triacetoxysilane, gamma-mercaptopropyltrimethoxysi lane, (3-aminopropyl)trimethoxysilane, (3-aminopropyl)triethoxysilane, N-beta-(aminoethyl)-gamma-aminopropyl-trimethoxysilane, N-(beta-aminoethyl)gamma-aminopropylmethyldimethoxysilane, aminoethylaminopropyl silane triol homopolymer, vinylbenzylaminoethylaminopropyltrimethoxysilane, and the like and mixtures thereof. Preferably, however, the inner surface of the glass outer layer is primed with an amino-silane, such as, (3-aminopropyl)trimethoxysilane, (3-aminopropyl)triethoxysilane, N-beta-(aminoethyl)-gamma-aminopropyl-trimethoxysilane, N-(beta-aminoethyl)gamma-aminopropylmethyldimethoxysilane, aminoethylaminopropyl silane triol homopolymer, vinylbenzylaminoethylaminopropyltrimethoxysilane, bis(trimethoxysilylpropyl)amine, and the like and mixtures thereof. Commercial examples of amino-silanes include,
DOW CORNING® Z-6011 Silane (Dow Corning Corporation, Midland, Mich. (“Dow Corning”)), SILQUEST A-1100 Silane and A-1102 Silane (GE Silicones, Friendly, WV (“GE Silicones”)), which are believed to be (3-aminopropyl)triethoxysilane);
DOW CORNING® Z-6020 Silane (Dow Corning) and SILQUEST® A-1120 Silane, (GE Silicones), which are believed to be N-beta-(aminoethyl)-gamma-aminopropyl-trimethoxysilane);
SILQUEST® A-2120 Silane (GE Silicones), which is believed to be N-(beta-aminoethyl)gamma-aminopropylmethyldimethoxysilane;
SILQUEST® A-1110 Silane (GE Silicones), which is believed to be gamma-aminopropyltrimethoxysilane.
DOW CORNING® Z-6137 Silane (Dow Corning), which is believed to be aminoethylaminopropyl silane triol homopolymer;
DOW CORNING® Z-6040 Silane (Dow Corning) and SILQUEST® A-187 Silane (GE Silicones), which are believed to be gamma-glycidoxypropyltrimethoxysilane;
DOW CORNING® Z-6130 Silane (Dow Corning), which is believed to be methacryloxypropyltrimethoxysilane;
DOW CORNING® Z-6132 Silane (Dow Corning), which is believed to be vinylbenzylaminoethylaminopropyltrimethoxysilane;
DOW CORNING® Z-6142 Silane (Dow Corning), which is believed to be gamma-glycidoxypropylmethyldiethoxysilane;
DOW CORNING® Z-6075 Silane (Dow Corning), which is believed to be vinyltriacetoxysilane;
DOW CORNING® Z-6172 Silane (Dow Corning) and SILQUEST® A-172 Silane (GE Silicones), which are believed to be vinyl tris(methoxyethoxy)silane;
DOW CORNING® Z-6300 Silane (Dow Corning) and SILQUEST® A-171 Silane (GE Silicones), which are believed to be vinyltrimethoxysilane;
DOW CORNING® Z 6518 Silane (Dow Corning) and SILQUEST® A-151 Silane (GE Silicones), which are believed to be vinyltriethoxysilane; and
SILQUEST® A-1170 Silane (GE Silicones), which is believed to be bis(trimethoxysilylpropyl)amine.

The preferred poly(alkyl amines) include those made from alpha olefin comonomers preferably incorporate from 2 to 10 carbon atoms. Preferable alpha olefins include, but are not limited to, ethylene, propylene, 1-butene, 1-pentene, 1-hexene, 1-heptene, 3-methyl-1-butene, 4-methyl-1-pentene, and the like and mixtures thereof. Even more preferred are poly(vinyl amines) and poly(allyl amines). An example of a poly(vinyl amine) is LUPAMIN® 9095 linear poly(vinyl amine) (BASF Corporation, Florham Park, N.J.). Poly(allyl amines) useful as adhesives for binding the glass to the interlayer include those described below for priming the polyester films.

The poly(alkyl amine) primer has primary amine functionality, and is preferably poly(vinyl amine) or poly(allyl amine), most preferably poly(allyl amine) (the most preferred of these are the linear poly(ally amines)).

The adhesives and primer may be applied through melt processes or through solution, emulsion, dispersion, and the like, coating processes. One of ordinary skill in the art will be able to identify appropriate process parameters based on the composition and process used for the coating formation. The above process conditions and parameters for making coatings by any method in the art are easily determined by a skilled artisan for any given composition and desired application. For example, the adhesive or primer composition can be cast, sprayed, air knifed, brushed, rolled, poured or printed or the like onto the film layer surface. Generally the adhesive or primer is diluted into a liquid medium prior to application to provide uniform coverage over the film surface. The liquid media may function as a solvent for the adhesive or primer to form solutions or may function as a non-solvent for the adhesive or primer to form dispersions or emulsions. Coatings may also be applied by spraying.

The polyester films are preferably bi-axially oriented poly(ethyleneterephthalate) (PET) films. The polyester films are surface-treated to enhance adhesion to the interlayer materials, and the preferred surface treatments are the poly(allyl amine) primers.

When the polyester films are used as the plastic outer layer, a clear anti-scratch and anti-abrasion hardcoat may be applied to its outside surface. Suitable hardcoat may be formed of polysiloxanes or cross-linked (thermosetting) polyurethanes, such as those disclosed in U.S. Pat. No. 5,567,529 and U.S. Pat. No. 5,763,089. Polysiloxane coated PET films can be obtained commercially from DuPont as SPALLSHIELD™ Composite sheeting. Also applicable herein are the oligomeric-based coatings disclosed in U.S. 2005/0077002, which compositions are prepared by the reaction of (A) hydroxyl-containing oligomer with isocyanate-containing oligomer or (B) anhydride-containing oligomer with epoxide-containing compound. In practice, prior to applying the hardcoat, the outside surface of the polyester film needs to undergo certain energy treatments or be coated with certain primers to enhance the bonding between the polyester films and the hardcoats. The certain energy treatments may be a controlled flame treatment or a plasma treatment. For example, flame treating techniques have been disclosed in U.S. Pat. No. 2,632,921; U.S. Pat. No. 2,648,097; U.S. Pat. No. 2,683,984; and U.S. Pat. No. 2,704,382, and plasma treating techniques have been disclosed in U.S. Pat. No. 4,732,814. The primers that are useful include poly(alkyl amines) and acrylic based primers, such as acrylic hydrosol (see e.g., U.S. Pat. No. 5,415,942). In the present application, a “hardcoated polyester film” or a “polyester film coated with an abrasion resistant hardcoat” refers to a polyester film having one surface coated with an anti-scratch and anti-abrasion hardcoat and that a suitable adhesive layer is applied in-between the polyester film and-the hardcoat, or that the polyester film has undergone an energy treatment prior to the application of the hardcoat.

Surface-treatments are used to increase the adhesion between the polyester film and the adjacent interlayer sheet. Preferably, the inner surface of the polyester film is primed with a poly(alkyl amine), preferably a poly(allyl amine). The poly(allyl amine) primer or coating, and its application to the polyester film surface(s) are described in U.S. Pat. No. 5,411,845; U.S. Pat. No. 5,770,312; U.S. Pat. No. 5,690,994; and U.S. Pat. No. 5,698,329. Generally, the polyester film is extruded and cast as a film by conventional methods, and the poly(alkyl amine) coating is applied to the polyester film, either before stretching or between the machine direction stretching and transverse direction stretching operations, and/or after the two stretching operations and heat setting in the stenter oven. It is preferred that the coating be applied before the transverse stretching operation so that the coated polyester web is heated under restraint to a temperature of about 220° C. in the stenter oven in order to cure the poly(alkyl amine) to the polyester surface. In addition to this cured coating, an additional poly(alkyl amine) coating can be applied on it after the stretching and stenter oven heat setting in order to obtain a thicker overall coating.

The glass/plastic laminates may further comprise other additional polyester films and interlayer sheets laminated in-between the first interlayer sheet and the hardcoated polyester film. In general, the other polyester films are preferably PET or bi-axially oriented PET films that are primed with a poly(alkyl amine), preferably poly(allyl amine), coating on both surfaces. The other interlayer sheets may be formed of any suitable polymers. Preferably, however, the other interlayer sheets are formed of polymers selected from the group consisting of poly(vinyl acetals), acid copolymers and ionomers thereof, polyurethanes, polyvinyl chloride, and ethylene vinyl acetates. More preferably, the other interlayer sheets are formed of ionomers.

Preferably, the glass/plastic laminates disclosed above, may have a structure as one of the following:
G^{s}/INTL¹/P-PET/HC;
G^{s}/INTL¹/P-PET-P/INTL²/P-PET/HC; and
G^{s}/INTL¹/[P-PET-P/INTL²]ₙ/P-PET/HC, wherein,
“G^{s}” is a glass plate having the inner surface primed with a silane or poly(alkyl amine) coating;
“INTL¹” is an interlayer sheet formed of a polymer selected from the group consisting of acid copolymers and ionomers thereof, polyurethanes, poly(vinyl acetals), polyvinyl chloride, and ethylene vinyl acetates;
“INTL²” is an interlayer sheet formed of a polymer selected from the group consisting of poly(vinyl acetals), acid copolymers and ionomers thereof, polyurethanes, polyvinyl chloride, and ethylene vinyl acetates;
“P-PET/HC” is a polyester film having one surface coated with a poly(alkyl amine) coating and the other surface with an abrasion resistant hardcoat;
“P-PET-P” is a polyester film having both surfaces coated with a poly(alkyl amine) coatings; and
“[P-PET-P/INTL²]ₙ” means that the bi-layer structure of “P-PET-P/INTL²” repeats itself “n” times within the laminate, wherein “n”=1-4.

Some preferred examples of the glass/plastic laminates disclosed herein may have a structure as one of the following:
G^{s}/ION/P-PET/HC;
G^{s}/ION/P-PET-P/ION/P-PET/HC;
G^{s}/ION/P-PET-P/PVB/P-PET/HC
G^{s}/ION/P-PET-P/ION/P-PET-P/ION/P-PET/HC; and
G^{s}/ION/P-PET-P/PVB/P-PET-P/ION/P-PET/HC,

wherein, “ION” refers to an ionomer interlayer sheet and “PVB” refers to a poly(vinyl butyral) interlayer sheet.

In a further embodiment, the invention is a glass/glass laminate comprising (i) a first outer layer formed of glass, in which the inner surface is primed with an adhesive material, preferably selected from the group consisting of silanes and poly(alkyl amines) and is adjacent to and adhered to, (ii) a first interlayer sheet formed of a thermoplastic polymer selected from the group consisting of acid copolymers and ionomers thereof, polyurethanes, poly(vinyl acetals), polyvinyl chloride, and ethylene vinyl acetates, which is adjacent to and adhered to, (iii) a polyester film having both surfaces primed with a poly(alkyl amine) coating, which is adjacent to and adhered to, (iv) a second interlayer sheet formed of a polymer selected from the group consisting of poly(vinyl acetals), acid copolymers and ionomers thereof, polyurethanes, polyvinyl chlorides, and ethylene vinyl acetates, which is in direct or indirect contact with (v) a second outer layer formed of glass. Preferably, the polymer of the first interlayer is an ionomer. In addition, the inner surface of the second glass outer layer may be further primed with a silane or poly(alkyl amine) coating when it is in direct contact with a sheet formed of a high modulus polymer, e.g., an ionomer.

Here again, the glass/glass laminates may further comprise other additional polyester films and interlayer sheets laminated in-between the second interlayer sheet and the second glass outer layer. In general, the other interlayer sheets may be formed of any suitable polymers. The other polyester films are preferably PET or bi-axially oriented PET films that are primed with poly(alkyl amine) coating on both surfaces. The other interlayer sheets are formed of polymers selected from the group consisting of poly(vinyl acetals), acid copolymers and ionomers thereof, polyurethanes, polyvinyl chlorides, and ethylene vinyl acetates. More preferably, the other interlayer sheets are formed of ionomers.

The glass/glass laminates disclosed above, may have a structure as one of the following:
G^{s}/INTL¹/P-PET-P/INTL²/G(or ^{s}G); and
G^{s}/INTL¹/[P-PET-P/INTL²]ₙ/G(or ^{s}G); and wherein,
“G” is a glass plate and “G^{s}” or “^{s}G” is a glass plate having the inner surface primed with a silane or poly(alkyl amine) coating;
“INTL¹” is an interlayer sheet formed of a polymer selected from the group consisting of acid copolymers and ionomers thereof, polyurethanes, poly(vinyl acetals), polyvinyl chlorides, and ethylene vinyl acetates;
“INTL²” is an interlayer sheet formed of a polymer selected from the group consisting of poly(vinyl acetals), acid copolymers and ionomers thereof, polyurethanes, polyvinyl chlorides, and ethylene vinyl acetates;
“P-PET-P” is a polyester film having both surfaces coated with a poly(alkyl amine) coating; and
“[P-PET-P/INTL²]ₙ” means that the bi-layer structure of “P-PET-P/INTL²” repeats itself “n” times within the laminate, wherein “n”=1-4.

Some preferred examples of the glass/glass laminates disclosed herein may have a structure as one of the following:
G^{s}/ION/P-PET-P/ION/^{s}G;
G^{s}/ION/P-PET-P/PVB/G;
G^{s}/ION/P-PET-P/ION/P-PET-P/ION/^{s}G; and
G^{s}/ION/P-PET-P/PVB/P-PET-P/ION/^{s}G;

wherein, “ION” refers to an ionomer interlayer sheet and “PVB” refers to a poly(vinyl butyral) interlayer sheet.

The ionomer interlayer sheets and the other interlayer sheets (particularly when intended for use in a safety laminate) generally have a thickness of about 5 to about 250 mils (0.127-6.35 mm), preferably about 10 to about 180 mils (0.254-4.57 mm), and more preferably about 15 to about 120 mils (0.381-3.05 mm).

The thickness of the adhesive and primer coatings can be up to about 1,000 nanometers (nm), or preferably, about 0.2 to about 1,000 nm, or more preferably, about 5 to about 500 nm, or yet more preferably, about 10 to about 200 nm1.

The glass lites, sheets or layers generally have a thickness of about 1 to about 380 mils (0.025-9.65 mm), preferably about 30 to about 300 mils (0.76-7.62 mm), and more preferably about 60 to about 250 mils (1.5-6.35 mm).

The hardcoat generally has a thickness of about 1 to about 4.5 microns, preferably about 1.5 to about 3.0 microns, and more preferably about 2.0 to about 2.5 microns.

### EXAMPLES

The following Examples and Comparative Examples are intended to be illustrative of the present invention, and are not intended in any way to limit the scope of the present invention.

### Comparative Examples 1-8

In these comparative examples, a set of four (4) different glass/plastic laminates, with their structures shown below, were made in duplicate for subsequent weathering tests in Arizona and in Florida:
CE1 and 5: G/ION/PPET/PARC
CE2 and 6: G/PVB/PPET/PARC
CE3 and 7: G/ION/PET/PARC
CE4 and 8: G/PVB/PET/PARC wherein,
“G” was a 90 mil thick annealed float glass washed with detergent and rinsed with de-ionized water;
“ION” was a 90 mil thick sheet formed of an ionomer comprising 19.0 wt % of acids, neutralized at 37%, and having a Melt Index (MI) of 2.6;
“PVB” was a 30 mil thick sheet formed of a low additive, high adhesion grade poly(vinyl butyral) BUTACITE® BE-1030 (DuPont);
“PARC” was a polysiloxane hardcoat such as disclosed in U.S. Pat. No. 5,069,942;
“PET” was a flame treated 7 mil thick CRONAR® PET film (DuPont); and
“PPET” was a 6.5 mil thick MELINEX® 535 PET film (DuPont) that is primed in-line on both sides with poly(allyl amine).

The laminates of CE1-8 were prepared as follows. First, the component layers for each laminate were arranged and laid up as above, with an additional glass cover-plate placed over the PARC side of each stack. The cover-plate glass used herein was the same type of glass used in the laminates except that the cover-plate glass had been treated with RAIN-X® windshield treatment solution (Shell, Houston, Tex.) in order to aid separation of the cover-plate from the PARC surface after autoclaving. The pre-laminate assemblies as prepared above were than placed into an autoclave where they were subjected to heat and pressure to bond the different layers together and thereby producing the glass/plastic laminates. In the lamination process, the autoclave pressure was taken to 200 psi and the temperature was held at 135° C. for 30 minutes. It took about 2 hours to complete the autoclaving step with the ramping up and then down of both the temperature and pressure. Thereafter, the laminates were removed from the vacuum bags and the cover-plates were detached from the finished glass/plastic laminates.

The Arizona weathering test was conducted following the EMMA® test protocol (Atlas Material Testing Company, DSET Laboratories, Phoenix, Ariz.) which conforms to ASTM G147-02 and ASTM G90-98. This EMMA® test protocol is an accelerated test which uses sunshine that is concentrated into a high intensity beam using parabolic mirrors.

Specifically, the first set of the sample laminates was exposed for 100 days resulting in exposure to 500 MJ/m² UV (295-385 nm) (a total radiation of 397,403 Langleys, which is equivalent to about 3 years of real time exposure in Arizona). The weathered samples were then inspected visually and the results were as follows.

For CE1, 3, 5, and 7, where the ionomeric interlayer was bonded to the glass outer layer directly, de-lamination between the two was observed. In addition, the ionomer interlayers were discolored to a yellowish tint and marked by “mud-cracking” on the surfaces. High haze was also developed on the interlayers.

For CE2, 4, 6, and 8, where the interlayers were formed of poly(vinyl butyral), the laminates remained intact, clear, and colorless.

A second set of the sample laminates were exposed for 297 days resulting in exposure to 1,000 MJ/m² UV (295-385 nm) (a total radiation of 860,227 Langleys, which is equivalent to about 6 years of real time exposure in Arizona). Similar results, but to a greater extent, were observed for this set of samples.

For CE1, the poly(allyl amine) primed PET film and the ionomeric interlayer sheet were still adhered to each other over ⅗ of the area. However the glass was completely separated from them and the ionomer interlayer was mud-cracked, yellowish, and hazy on the side adjacent to the glass. In addition, the de-laminated structure was severely bowed out toward the plastic side.

For CE5, similar de-lamination effects as CE1 were observed in this sample, except that the poly(allyl amine) primed PET film and the ionomer interlayer sheet were tightly adhered to each over almost all of the surface area.

For CE3, all layers were loose and separated from each other and the PET film was dusty on both sides. The ionomer interlayer was still fairly flat but severely mud-cracked, yellowish, and hazy on the side that was adjacent to the glass outer layer.

For CE7, similar de-lamination effects as CE3 were observed, except that the ionomer interlayer was not as severely mud-cracked on the side that was adjacent to the glass.

Here again, for CE2, 4, 6, and 8, where the interlayer was formed of poly(vinyl butyral), the laminates remained intact, clear and colorless.

Results from these Arizona weathering tests are also tabulated in Table 1.

TABLE 1

| | | | | | | | | | | | | Laminate visual | | |
|---|---|---|---|---|---|---|---|---|---|---|---|---|---|---|
| | | | b* Color | | | Tvis (%) | | | Haze (%) | | | Inspection Results | | |
| Sample | Interlayer | PET | | 500 | 1,000 | | 500 | 1,000 | | 500 | 1,000 | | 500 | 1,000 |
| No. | Type | Type | 0 MJ | MJ | MJ | 0 MJ | MJ | MJ | 0 MJ | MJ | MJ | 0 MJ | MJ | MJ |
| 4 | PVB | PET | 1.16 | 0.96 | 1.05 | 92.1 | 91.9 | 92.0 | 0.40 | 0.54 | 0.56 | good | good | good |
| 8 | PVB | PET | 1.14 | 1.01 | 1.21 | 91.3 | 91.9 | 91.1 | 1.50 | 0.70 | 1.74 | good | good | good |
| 2 | PVB | PPET | 1.12 | 1.18 | 1.19 | 91.4 | 91.1 | 91.1 | 1.63 | 1.69 | 1.83 | good | good | good |
| 6 | PVB | PPET | 1.08 | 1.16 | 1.16 | 92.0 | 91.2 | 1.6 | 0.49 | 1.71 | 1.55 | good | good | good |
| 3 | ION | PET | 1.56 | 1.84 | 1.05 | 91.4 | 91.1 | 61.4 | 2.79 | 1.25 | 74.00 | good | D-L | D-L |
| 7 | ION | PET | 1.48 | 2.12 | 3.42 | 91.4 | 90.6 | 74.6 | 0.94 | 1.93 | 37.80 | good | D-L | D-L |
| 1 | ION | PPET | 1.55 | 2.02 | 3.37 | 90.6 | 90.5 | 66.2 | 2.94 | 3.22 | 43.7 | good | D-L | D-L |
| 5 | ION | PPET | 1.53 | 5.16 | 3.14 | 90.6 | 86.9 | 73.5 | 2.22 | 8.3 | 27.2 | good | D-L | D-L |

Note:
“Good” was used to mean that no de-lamination was observed.
“D-L” was used to mean that de-lamination was observed.

### Comparative Examples 9-13 and Example 1

Using the same lamination process, laminates with the following structures were prepared:
CE9: G/90 mil ION/G
CE10: G/90 mil ION/PPET/PARC
E1: G^{s}/90 mil ION/PPET/PARC
CE11: G/30 mil PVB/PPET/60 mil ION/P-PET/PARC
CE12: G/90 mil PVB/PPET/PARC
CE13: G/90 mil PVB/G
CE14: G^{s}/90 mil ION/G^{s}

In these samples, “G^{s}” referred to a glass plate primed with an amino-silane coating, which was prepared as follows. First, a 0.05% amino-silane solution was prepared by mixing 0.5 ml of SILQUEST® A-1110 Silane (GE Silicones) with 100 g of a solution containing 2 parts by weight of isopropanol and 1 part by weight of water. The mixture was then stirred at room temperature for about 30 to 60 min before use. The diluted amino-silane solution was then applied to the glass plates by wiping the solution onto the glass surface, or spraying the glass surface with the solution, or immersing the glass plate into the solution, followed by wiping the glass surface with a dry cloth until it was free of any haziness. The primed surface of the glass plate was then placed against the interlayer for further lamination process.

For further weathering tests, the laminates listed above were subjected to EMMA® test in Arizona by exposing the laminates for 178 days resulting in exposure to 500 MJ/m² UV (295-385 nm) (a total radiation of 448,539 Langleys, which is equivalent to about three years of real time exposure in Arizona). During the test, the laminates were mounted with the glass sides facing the sun and the plastic sides facing the interior air-shaft of the test device. The following was observed after the test was completed:
CE9: The laminate remained intact and was clear and colorless.
CE10: One sample totally delaminated at the glass-to-ionomer interface and the duplicate sample partially delaminated at the same interface.
E1: The laminate remained intact and was clear and colorless.
CE11: The laminate remained intact and was clear and colorless.
CE12: The laminate remained intact and was clear and colorless.
CE13: The laminate remained intact and was clear and colorless.
CE14: The laminate remained intact and was clear and colorless.

In summary, the use of amino-silane primed glass in laminates E1 (G^{s}/90 mil ION/P-PET/PARC) prevented spontaneous de-lamination that was observed with laminate CE10 (G/90 mil ION/P-PET/PARC), which demonstrated that the use of amino-silane priming agents at the glass-ionomer interface prevents de-lamination in ionomer based glass/plastic laminates and therefore improve the weatherability of the laminates.

It is also noted that when glass plates are applied to both sides of the ionomeric interlayer (CE9 and 14), regardless of the priming condition of the glass plates, the laminates suffered no de-lamination. It is believed that in these situations, the rigid glass plates on each side of the ionomeric interlayer provide sufficient protection to the interlayer sheets and therefore prevent any spontaneous de-lamination.

In glass/plastic laminates CE11 and 12, where the unprimed glass plate was adjacent to and adhered to an interlayer made of poly(vinyl butyral) instead of ionomer, due to the softness of poly(vinyl butyral) and its much higher adhesion strength to glass, the laminates suffered no de-lamination.

### Comparative Examples CE15-18 and Examples 2-7

In this set of samples, a set of poly(vinyl butyral) based or ionomer based glass/plastic laminates with the following structures were prepared using a similar lamination process described in the previous examples:

G/INTL/PPET/PARC,

wherein,

“G” was 90 mil annealed float glass, unprimed, or primed with an amino-silane or a poly(allyl amine) coating;

“INTL” was an interlayer sheet formed of poly(vinyl butyral) or ionomer;

“PPET” was a 7.0 mil thick PET film primed with polyallylamine on both sides;

“PARC” was a polysiloxane hardcoat as disclosed in U.S. Pat. No. 5,069,942.

The above glass/plastic laminates were tested following protocol SAE J1960 for 1,000 hours. This test involved exposing the laminates to intense Xenon-arc radiation with water spray and dark cycles. The laminates were exposed with the glass sides facing the central radiation source and the plastic sides were covered with opaque black aluminum panels to prevent any back-scattered radiation from impinging onto the plastic sides. Results of the test are shown in Table 2.

TABLE 2

| Sample | Interlayer | | Haze (%) | | | b* Color | | | Pummel^{a} |
|---|---|---|---|---|---|---|---|---|---|
| No. | Type | Primer on Glass | Unexposed | Exposed | Change | Unexposed | Exposed | Change | after Exposure |
| CE15 | PVB | None | 0.85 | 1.01 | 0.16 | 1.42 | 1.16 | −0.26 | 3 |
| CE16 | PVB | A-1110 (0.05%) | 1.15 | 0.93 | −0.22 | 1.68 | 1.20 | −0.48 | 8 |
| CE17 | ION | None | 0.89 | 13.30 | 12.41 | 1.45 | 4.24 | 2.79 | 0 |
| E2 | ION | A-1110 (0.05%) | 1.28 | 1.36 | 0.08 | 1.55 | 1.85 | 0.30 | 8 |
| E3 | ION | A-1110 (0.10%) | 1.10 | 0.87 | −0.23 | 1.54 | 1.82 | 0.28 | 4 |
| E4 | ION | PAA (0.10%) | 0.93 | 0.95 | 0.02 | 1.44 | 1.77 | 0.33 | 5 |
| CE18 | IONa | None | 1.90 | 16.40 | 14.50 | 1.71 | 3.12 | 1.41 | 0 |
| E5 | IONa | A-1110 (0.05%) | 2.15 | 1.55 | −0.60 | 1.77 | 1.97 | 0.20 | 6 |
| E6 | IONa | A-1110 (0.10%) | 1.49 | 1.23 | −0.26 | 1.39 | 1.72 | 0.33 | 5 |
| E7 | IONa | PAA (0.10%) | 1.84 | 1.24 | −0.60 | 1.80 | 1.93 | 0.13 | 8 |

^{a}The pummel test involves striking the laminate, resting at a slight angle to the horizontal, on the glass side with a hammer to crush the glass. The pummel rating is a visual measure of the amount of glass remaining adhered to the underlying interlayer, with a 0 rating indicating no adhesion between the glass and the interlayer and a 10 indicating perfect adhesion. The pummel is run at −18 degrees centigrade for laminates using PVB as the interlayer and at room temperature for laminates using ionomer as the interlayer.
Note:
PVB was a 30 mil thick BUTACITE ® B52 poly(vinyl butyral) sheet (DuPont).
ION was a 60 mil thick interlayer sheet formed of SURLYN ® (DuPont), an ionomer resin comprising 19.0 wt % of acid that was 37% neutralized with sodium and having a Ml of 2.0.
IONa was a 60 mil thick interlayer sheet formed of SURLYN ® (DuPont), an ionomer resin comprising 20.5 wt % of acid that was 29% neutralized and having a Ml of 2.0.
A-1110 (0.05%) and A-1110 (0.10%) were SILQUEST ® A -1110 Silane (GE Silicones) diluted in a 2/1 isopropanol/water solvent.
PAA (0.10%) was 20 wt % solution of poly(allyl amine) in water with a molecular weight of 17,000 (Aldrich), which was further diluted to 0.10% in a 2/1 isopropanol/water solvent.

Results from a visual inspection of the laminates after exposure were as follows:

CE15: Laminates remained clear and integral.

CE16: Laminates remained clear and integral.

CE17: The ionomer interlayer was totally delaminated from the unprimed glass but still adhered to the poly(allyl amine) primed PET film.

E2: Laminates remained clear and integral.

E3: Laminates remained clear and integral.

E4: Laminates remained clear and integral except for some slight separation between the ionomer interlayer and the glass at several edges.

CE18: The ionomer interlayer was totally separated from the unprimed glass but still adhere to the poly(allyl amine) primed PET film.

E5: Laminates remained clear and integral.

E6: Laminates remained clear and integral.

E7: Laminates remained clear and integral.

In summary, the poly(vinyl butyral) based glass/plastic laminates, with either primed or unprimed glass, survived the weathering test very well and remained suitable for use. For the ionomer based glass/plastic laminates, however, only those where the glass outer layers are primed with an amino-silane or poly(allyl amine) coating, survived the weathering tests and remained suitable for use. Those ionomer based glass/plastic laminates including unprimed glass outer layers were essentially destroyed by complete de-lamination.

Additionally, adhesion strength on all the sample laminates disclosed above was measured by the Pummel Test, where the laminates were struck on the glass sides with a hammer repeatedly in a proscribed way and the adhesion was estimated by the amount of glass particles still adhered to the glass. A detailed description of the test may be found in U.S. Pat. No. 5,618,863. Results of the Pummel Test are shown in Table 2.

1. A glass laminate comprising:
(i) a glass outer layer having its outer surface as a first outer most surface of the glass laminate and its inner surface primed with an adhesive material and being positioned next to and adhered to,
(ii) a first polymeric interlayer comprising a first polymer selected from partially or fully neutralized ionomeric copolymers of alpha olefins and alpha,beta-unsaturated carboxylic acids having from 3 to 8 carbons which has its first surface adjacent to and adhered to the glass outer layer and its second surface facing to,
(iii) a first surface-treated polyester film outer layer having its inner surface facing to the first polymeric interlayer and its out surface that faces away from the first polymeric interlayer as a second outer most surface of the glass laminate.

2. The glass laminate of claim 1, wherein the adhesive material is selected from the group consisting of silanes and poly(alkyl amines).

3. A glass laminate comprising:
(i) a glass outer layer having its outer surface as a first outer most surface of the glass laminate and its inner surface primed with an adhesive material and being positioned next to and adhered to,
(ii) a first polymeric interlayer comprising a first polymer selected from partially or fully neutralized ionomeric copolymers of alpha olefins and alpha,beta-unsaturated carboxylic acids having from 3 to 8 carbons, which has its first surface adjacent to and adhered to the glass outer layer and its second surface facing to,
(iii) a first polyester film outer layer having its inner surface that faces to the first polymeric interlayer primed with a poly(alkyl amine) and its outer surface that faces away from the first polymeric interlayer as a second outer most surface of the glass laminate.

4. The glass laminate of claim 3, wherein the adhesive material is selected from the group consisting of silanes and poly(alkyl amines).

5. The glass laminate of claim 3, wherein the poly(alkyl amine) is selected from the group consisting of poly(allyl amines).

6. A glass laminate comprising:
(i) a glass outer layer having its outer surface as a first outer most surface of the glass laminate and its inner surface primed with an adhesive material selected from the group consisting of silanes and poly(alkyl amines) and being positioned next to and adhered to,
(ii) a first polymeric interlayer comprising a first polymer selected from partially or fully neutralized ionomeric copolymers of alpha olefins and alpha,beta-unsaturated carboxylic acids having from 3 to 8 carbons which has its first surface adjacent to and adhered to the glass outer layer and its second surface facing to,
(iii) a first polyester film outer layer having its inner surface that faces to the first polymeric interlayer primed with poly(allyl amine) and its outer surface that faces away from the first polymeric interlayer as a second outer most surface of the glass laminate.

7. The glass laminate of claim 6 wherein the inner surface of the glass outer layer is primed with the silane and the silane is amino-silane.

8. The glass laminate of claim 7 wherein the inner surface of the glass outer layer is primed with the poly(alkyl amine).

9. The glass laminate of claim 7, wherein the amino-silane is selected from the group consisting of (3-aminopropyl)trimethoxysilanes, (3-aminopropyl)triethoxysilanes, N-beta-(aminoethyl)-gamma-aminopropyl-trimethoxysilanes, N-(beta-aminoethyl) gamma-aminopropylmethyldimethoxysilanes, aminoethylaminopropyl silane triol homopolymers, vinylbenzylaminoethylaminopropyltrimethoxysilanes, and bis(trimethoxysilylpropyl)amines.

10. The glass laminate of claim 8, wherein the poly(alkyl amine) is selected from the group consisting of poly(vinyl amines), poly(allyl amines), and mixtures thereof.

11. The glass laminate of claim 6, wherein the first polyester film outer layer is a poly(ethylene terephthalate) film.

12. The glass laminate of claim 1, wherein the first polyester film outer layer has its outer surface coated with an abrasion resistant hardcoat.

13. The glass laminate of claim 3, wherein the first polyester film outer layer is a poly(ethylene terephthalate) film, which has its outer surface coated with an abrasion resistant hardcoat.

14. The glass laminate of claim 11, wherein the first polyester film outer layer has its outer surface coated with an abrasion resistant hardcoat.

15. The glass laminate of claim 14, wherein the abrasion resistant hardcoat is formed of a material selected from the group consisting of polysiloxanes, cross-linked polyurethanes, and composition prepared by the reaction of (A) hydroxyl-containing oligomer with isocyanate-containing oligomer or (B) anhydride-containing oligomer with epoxide-containing compound.

16. The glass laminate of claim 6, further comprising:
(iv) a second polyester film layer having its first surface primed with poly(allyl amine) and adjacent to and adhered to the second surface of the first polymeric interlayer and its second surface adjacent to and adhered to,
(v) a second polymeric interlayer comprising a second polymer selected from the group consisting of poly(vinyl acetals), acid copolymers of alpha olefins and alpha,beta-unsaturated carboxylic acid having from 3 to 8 carbons, partial or fully neutralized ionomeric copolymers of alpha olefins and alpha,beta-unsaturated carboxylic acids having from 3 to 8 carbons, polyurethanes, polyvinyl chlorides, and ethylene vinyl acetates, which has its first surface adjacent to and adhered to the second polyester film layer and its second surface facing to the first polyester film outer layer.

17. The glass laminate of claim 16, wherein, (a) the second polymer of the second polymeric interlayer is selected from the partially or fully neutralized ionomeric copolymers of alpha olefins and alpha,beta-unsaturated carboxylic acids having from 3 to 8 carbons; (b) the second polyester film layer has both of its surfaces primed with the poly(allyl amine); and (c) the first polyester film outer layer has its outer surface coated with an abrasion resistant hardcoat.

18. The glass laminate of claim 16, wherein, (a) the second polymer of the second polymeric interlayer is selected from the poly(vinyl acetals), wherein the poly(vinyl acetals) are selected from the group consisting of poly(vinyl butyrals); and (b) the first polyester film outer layer has its outer surface coated with an abrasion resistant hardcoat.

19. The glass laminate of claim 16, further comprising:
(vi) a third polyester film layer having its first surface primed with poly(allyl amine) and adjacent to and adhered to the second surface of the second polymeric interlayer and its second surface adjacent to and adhered to,
(vii) a third polymeric interlayer comprising a third polymer selected from the group consisting of poly(vinyl butyrals), acid copolymers of alpha olefins and alpha,beta-unsaturated carboxylic acids having from 3 to 8 carbons, partially or fully neutralized ionomeric copolymers of alpha olefins and alpha,beta-unsaturated carboxylic acids having from 3 to 8 carbons, polyurethanes, poly(vinyl acetals), polyvinyl chlorides, and ethylene vinyl acetates, which has its first surface adjacent to and adhered to the third polyester film layer and its second surface facing to the first polyester film outer layer.

20. The glass laminate of claim 19, wherein, (a) the second and third polymers of the second and third polymeric interlayers are selected from partially or fully neutralized ionomeric copolymers of alpha olefins and alpha,beta-unsaturated carboxylic acids having from 3 to 8 carbons; (b) the second and third polyester films layers are primed with the poly(allyl amine) on both surfaces; and (c) the first polyester film outer layer has its outer surface coated with an abrasion resistant hardcoat.

21. The glass laminate of claim 19, wherein, (a) the second polymer of the second polymeric interlayer is poly(vinyl butyral); (b) the third polymer of the third polymeric interlayer is partially or fully neutralized ionomeric copolymers of alpha olefins and alpha,beta-unsaturated carboxylic acids having from 3 to 8 carbons; and (c) the first polyester film outer layer has its outer surface coated with an abrasion resistant hardcoat.

22-24. (canceled)

25. The glass laminate of claim 12, which consists essentially of:
(i) the glass outer layer having its inner surface primed with the adhesive material,
(ii) the first polymeric interlayer, and
(iii) the first polyester film outer layer having its inner surface primed with the poly(alkyl amine) and its outer surface coated with the abrasion resistant hardcoat.

26. The glass laminate of claim 17, which consists essentially of:
(i) the glass outer layer having its inner surface primed with the adhesive material,
(ii) the first polymeric interlayer,
(iii) the second polyester film layer having both surfaces primed with the poly(allyl amine),
(iv) the second polymeric interlayer, and
(v) the first polyester film outer layer having its inner surface primed with the poly(allyl amine) and its outer surface coated with the abrasion resistant hardcoat.

27. The glass laminate of claim 18, which consists essentially of:
(i) the glass outer layer having its inner surface primed with the adhesive material,
(ii) the first polymeric interlayer,
(iii) the second polyester film layer having at least its first surface that is adjacent to the first polymeric interlayer primed with the poly(allyl amine),
(iv) the second polymeric interlayer, and
(v) the first polyester film outer layer having its outer surface that is farther away from the second polymeric layer coated with the abrasion resistant hardcoat.

28. The glass laminate of claim 20, which consists essentially of:
(i) the glass outer layer having its inner surface primed with the adhesive material,
(ii) the first polymeric interlayer,
(iii) the second polyester film layer having both surfaces primed with the poly(allyl amine),
(iv) the second polymeric interlayer,
(v) the third polyester film layer having both surfaces primed with the poly(allyl amine),
(vi) the third polymeric interlayer, and
(vii) the first polyester film outer layer having its inner surface primed with the poly(allyl amine), and its outer surface coated with the abrasion resistant hardcoat.

29. The glass laminate of claim 21, which consists essentially of:
(i) the glass outer layer having its inner surface primed with the adhesive material,
(ii) the first polymeric interlayer,
(iii) the second polyester film layer having at least its first surface that is adjacent to the first polymeric interlayer primed with the poly(allyl amine),
(iv) the second polymeric interlayer,
(v) the third polyester film layer having at least its second surface that is farther away from the second polymeric interlayer primed with the poly(allyl amine),
(vi) the third polymeric interlayer, and
(vii) the first polyester film outer layer having its inner surface that is adjacent to the third polymeric interlayer primed with the poly(allyl amine), and its outer surface coated with the abrasion resistant hardcoat.

30-31. (canceled)

32. The glass laminate of claim 6 wherein (i) the first polymer is the partially neutralized ionomeric copolymer, (ii) the alpha olefin is selected from the group consisting of ethylene, propylene, 1-butene, 1-pentene, 1-hexene, 1-heptene, 3methyl-1-butene, 4-methyl-1-pentene and mixtures thereof, (iii) the alpha, beta-ethylenically unsaturated carboxylic acid is selected from the group consisting of acrylic acid, methacrylic acid, itaconic acid, maleic acid, maleic anhydride, fumaric acid, monomethyl maleic acid and mixtures thereof, and (iv) about 5 to about 90% of the carboxylic acids are neutralized with a metal ion.

33. The glass laminate of claim 6 wherein (i) the first polymer is the partially neutralized ionomeric copolymer, (ii) the alpha olefin is ethylene, (iii) the alpha,beta -unsaturated carboxylic acid is selected from the group consisting of acrylic acid, methacrylic acid or mixtures thereof, and (iv) about 5 to about 90% of the carboxylic acids are neutralized with a metal ion.

34. The glass laminate of claim 1 wherein the first polymeric interlayer has a thickness of about 10 to about 250 mils.

35. The glass laminate of claim 6 wherein the first polymeric interlayer has a thickness, of about 30 to about 60 mils, the adhesive material has a thickness of up to about 1,000 nm, and the poly(allyl amine) has a thickness of up to about 1,000 nm.
